(19) United States
(12) Patent Application Publication
(10) Pub. No.: US 2008/0087059 A1
(43) Pub. Date: Apr. 17, 2008

(54) APPARATUS FOR LOCKING ROOF RACKS AND CROSS BARS OF ROOF CARRIER

(75) Inventor: Cheon Bok Lee, Busan (KR)

Correspondence Address: Hyun Jong Park;TUCHMAN & PARK LLC, 41 White Birch Road, Redding, CT, 06896-2209, US

(73) Assignee: MOLDPIA Co., Ltd., Ulsan-si (KR)

(21) Appl. No.: 11/871,822

(22) Filed: Oct. 12, 2007

(30) Foreign Application Priority Data
Oct. 12, 2006 (KR) 10-2006-0099344
Dec. 15, 2006 (KR) 10-2006-0128297
Mar. 20, 2007 (KR) 10-2007-0027201

(51) Int. Cl. E05B 65/12

(52) U.S. Cl. 70/258

(57) ABSTRACT

An apparatus for locking roof racks and cross bars of a roof carrier realizes easy production and reduction in production costs through structural simplification. The apparatus comprises a pair of roof racks, in an inner surface of each of which a plurality of fixing holes is formed at regular intervals; at least two cross bars, each of which is coupled with the roof racks at opposite ends thereof in the widthwise direction of the vehicle; a pair of fixing members, which are located at opposite ends of the cross bar and are detachably coupled to the fixing holes in the roof racks; operating means, which are coupled to the opposite ends of the cross bar so as to couple and uncouple each fixing member to and from each fixing hole; and a connecting means, which connects the fixing members so as to interact with the fixing members in the cross bar.

### FIELD OF THE INVENTION

The present invention relates to an apparatus for locking roof racks and cross bars of a roof carrier and, more particularly, to an apparatus for locking roof racks and cross bars of a roof carrier, capable of separating opposite fixing members from fixing holes by the operation of an operating means using a simple connecting means, in which a pair of supports is fixed to a pivotable central link coupled to an elastic member.

### BACKGROUND OF THE INVENTION

In general, a roof carrier refers to a fitting that is mounted on the roof panel of a vehicle in order to solve the problem of insufficient storage space, attributable to the small space inside the vehicle, and thereby enables leisure or sports equipment and other goods to be loaded thereon.

FIG. 1 is a perspective view illustrating an example of how roof racks and cross bars of an existing roof carrier are used. FIG. 2 is an exploded perspective view illustrating an apparatus for locking roof racks and cross bars of an existing roof carrier.

As illustrated in FIG. 1, the existing roof carrier 1 is mounted on the roof panel 2 of a vehicle, and comprises roof racks 10 (called side bars) installed on opposite sides of the roof panel in the lengthwise direction of the vehicle, and cross bars 20, coupled with the roof racks 10 at opposite ends thereof, in the widthwise direction of the vehicle.

Each cross bar 20 of the roof carrier 1 is required to be adjustable in the length thereof depending on the size of loaded goods. As such, it is necessary for one operator to easily lock and unlock the cross bars 20.

In order to solve this problem, Korean Patent No. 0609489, and U.S. Pat. Nos. 6,779,696 and 6,131,782 have been proposed.

As illustrated in FIG. 2, each fixing member 30 is adapted to be detachably coupled to one of fixing holes 12, which are formed in each roof rack at regular intervals, and then each cross bar is coupled with rails 14 of the roof rack 10 by rotary rollers 22 so as to be movable forwards and backwards.

However, this coupling structure has various drawbacks from the viewpoint of use in that a single user cannot release the opposite sides at the same time, in that it is difficult to operate an operating means, in that a great force is required to shift the fixing members, in that production is difficult due to the complicated structure thereof, and in that high expenses are incurred upon production thereof.

### SUMMARY OF THE INVENTION

Accordingly, the present invention has been made keeping in mind the above problems occurring in the related art, and an object of the present invention is to provide an apparatus for locking roof racks and cross bars of a roof carrier, capable of realizing easy production and a reduction in production costs through structural simplification.

Another object of the present invention is to provide an apparatus for locking roof racks and cross bars of a roof carrier, capable of realizing convenient operation.

According to an aspect of the present invention, there is provided an apparatus for locking roof racks and cross bars of a roof carrier, in which the roof racks are fixed to opposite upper sides of a vehicle in the lengthwise direction of the vehicle, and each cross bar is coupled with the roof racks at opposite ends thereof in the widthwise direction of the vehicle. The apparatus comprises: a pair of roof racks, in an inner surface of each of which a plurality of fixing holes is formed at regular intervals; at least two cross bars, each of which is coupled to the pair of roof racks so as to be movable forwards and backwards; a pair of fixing members, which are located at opposite ends of the cross bar and are detachably coupled to the fixing holes in the roof racks; operating means, coupled to the opposite ends of the cross bar, for operating each fixing member to be coupled to and uncoupled from each fixing hole; and connecting means for connecting the fixing members so that they interact with the fixing members in the cross bar. Thereby, the pair of fixing members is uncoupled from the fixing holes by operating one of the operating means.

According to an aspect of the present invention, the operating means connects the fixing members to a pair of manipulation buttons, which protrude upward from the opposite sides of the cross bar and can horizontally move left and right, so that one of the manipulation buttons is operated to couple and decouple the pair of fixing members to and from the fixing holes in the roof racks.

According to an aspect of the present invention, the connecting means comprises: a central link, the center of which is pivotably fixed in a middle of an interior of the cross bar; an elastic member, opposite ends of which are fixed to the central link and the interior of the cross bar, respectively, so as to provide restoring force; and a pair of supports, each of which is fixed to one end of the central link at one end thereof and is hinged to each fixing member at the other end thereof, and one of which moves to causes the other one thereof to move in the opposite direction.

According to an aspect of the present invention, the elastic member comprises a spiral spring or a coil spring.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view illustrating an example of how the roof racks and the cross bars of an existing roof carrier are used;

FIG. 2 is an exploded perspective view illustrating an apparatus for locking the roof racks and the cross bars of an existing roof carrier;

FIG. 3 is a conceptual view illustrating an apparatus for locking roof racks and cross bars of a roof carrier according to a first exemplary embodiment of the present invention;

FIGS. 4A and 4B are views for explaining the operation of an apparatus for locking roof racks and cross bars of a roof carrier according to a first exemplary embodiment of the present invention;

FIG. 5 is a conceptual view illustrating an apparatus for locking roof racks and cross bars of a roof carrier according to a second exemplary embodiment of the present invention;

FIG. 6 is a sectional view illustrating the state in which fixing members are decoupled from fixing holes in roof racks in accordance with a second embodiment of the present invention;

FIGS. 7A and 7B are views for explaining the operation of an apparatus for locking roof racks and cross bars of a roof carrier according to a second embodiment of the present invention;

FIG. 8 is an exploded perspective view illustrating an apparatus for locking roof racks and cross bars of a roof carrier according to a second exemplary embodiment of the present invention;

FIG. 9 is a conceptual view illustrating an apparatus for locking roof racks and cross bars of a roof carrier according to a third exemplary embodiment of the present invention;

FIGS. 10A and 10B are views for explaining the operation of an apparatus for locking roof racks and cross bars of a roof carrier according to a third exemplary embodiment of the present invention;

FIG. 11 is a conceptual view illustrating an apparatus for locking roof racks and cross bars of a roof carrier according to a fourth exemplary embodiment of the present invention; and

FIGS. 12A and 12B are views for explaining the operation of an apparatus for locking roof racks and cross bars of a roof carrier according to a fourth exemplary embodiment of the present invention.

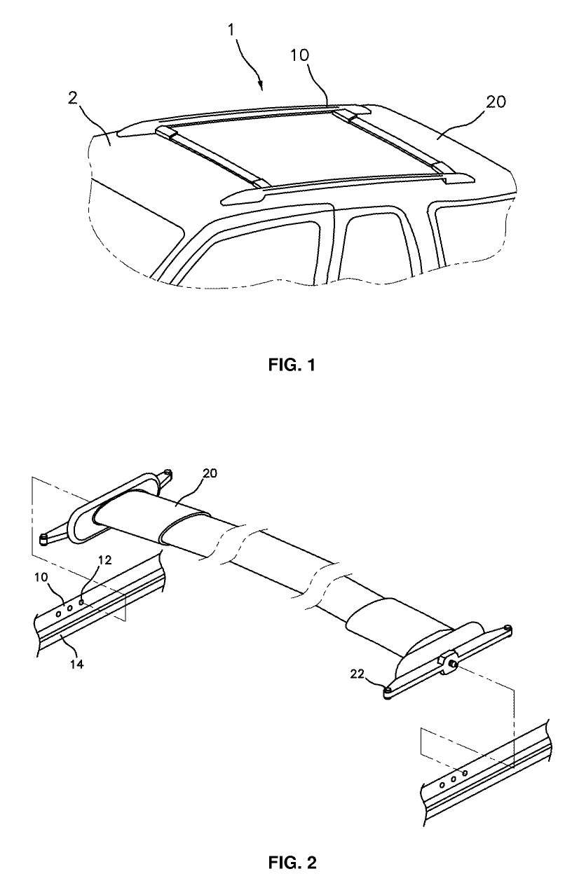

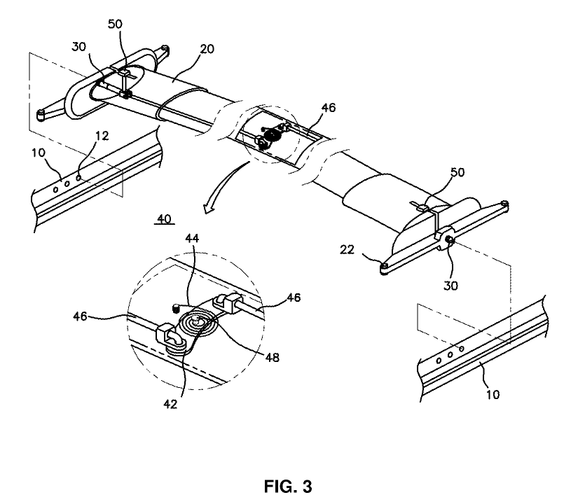

### DETAILED DESCRIPTION OF THE INVENTION

Reference will now be made in greater detail to an apparatus for locking the roof rack and the cross bar of a roof carrier according to exemplary embodiments of the invention, an example of which is illustrated in the accompanying drawings. Wherever possible, the same reference numerals will be used throughout the drawings and the description to refer to the same or like parts.

### First Embodiment

FIG. 3 is a conceptual view illustrating an apparatus for locking roof racks and cross bars of a roof carrier according to a first exemplary embodiment of the present invention.

As illustrated in FIG. 3, the locking apparatus comprises: a pair of roof racks 10, in an inner surface of each of which a plurality of fixing holes 12 is formed at regular intervals; at least two cross bars 20, each of which is coupled with the roof racks 10 at opposite ends thereof in the widthwise direction of the vehicle; a pair of fixing members 30, which are located at opposite ends of the cross bar and are detachably coupled to the fixing holes in the roof racks; operating means, which are coupled to the opposite ends of the cross bar so as to couple and uncouple each fixing member to and from each fixing hole; and a connecting means 40, which connects the fixing members so that they interact with the fixing members in the cross bar.

First, as for the structure of coupling the roof racks and the cross bar, the roof racks 10, which are fixed on opposite upper sides of the vehicle, are formed with the fixing holes 12, into which the fixing members 30 are inserted, so that the cross bars 20 can be moved forward and backward, and can then be fixed.

Further, the cross bar 20 is preferably coupled with rotary rollers 22 at opposite ends thereof so as to be smoothly moved.

Hereinafter, the components for locking the roof racks and the cross bars will be described.

The connecting means 40 comprises a central link 42, an elastic member 44, opposite ends of which are fixed to the central link 42 and the interior of each cross bar 20 respectively, and a pair of supports 46, each of which is fixed to one end of the central link 42 at one end thereof and is hinged to each fixing member 30 at the other end thereof, and one of which moves to causes the other one thereof to move in the opposite direction.

The central link 42 is pivotably coupled to a pin 48 at the center thereof which is formed at the center of the interior of each cross bar 20. The elastic member 44, the opposite ends of which are fixed to the central link 42 and each cross bar 20, respectively, functions to provide an elastic force caused by the pivoting of the central link 42. The elastic member 44 is preferably formed of a spiral spring.

Next, the fixing members 30 and the supports 46 will be described.

Each fixing member 30 is coupled to or uncoupled from any one of the fixing holes 12, which are formed at each roof rack 10 at regular intervals. Thus, the fixing members 30 serve to fix the cross bars 20.

Further, the fixing members 30 are preferably connected to a pair of manipulation buttons 50, which protrude upward from the opposite sides of each cross bar 20 and can horizontally move left and right, so as to be able to be easily manipulated by a user.

Next, the supports 46, each of which is fixed to the central link 42 at one end thereof and is hinged to each fixing member 30 at the other end thereof, function to transmit the movement of one of the fixing members 30 to the other fixing member.

Further, the supports 46 are formed of a steel rod, unlike a wire, used as an existing connector member, and are fixed to the opposite ends of the central link 46 in opposite directions. Thus, the operation of only one of the supports 46 can control the operation of the other support.

In addition, since each cross bar used for the vehicle usually has a curved shape, rather than a linear shape, the supports 46 are preferably hinged with respective fixing members 30, and are installed in the cross bar in a curved form so as to avoid any contact with an inner surface of the cross bar.

The operation of the supports 46 and the central link 42 will be described below.

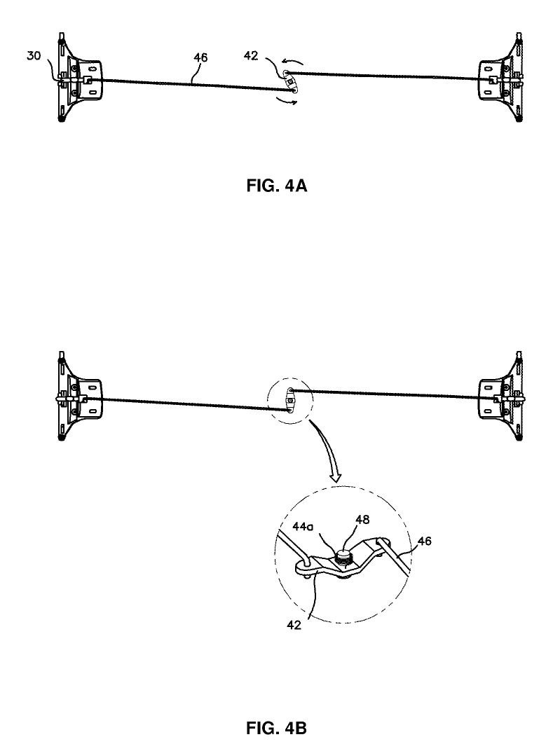

FIGS. 4A and 4B are views for explaining the operation of an apparatus for locking roof racks and cross bars of a roof carrier according to a first exemplary embodiment of the present invention.

Here, FIG. 4A illustrates the state in which, when a manipulation button is shifted by the manipulation of a user, the fixing members are decoupled from the fixing holes in the roof racks, and are thereby moved into the interior of the cross bar, and FIG. 4B illustrates the state in which the fixing members are moved toward the exterior of each cross bar again by means of an elastic force of the elastic member, and are coupled to the fixing holes in the roof racks.

When one of the supports, which are fixed to the opposite ends of the central link in the middle of the cross bar, is moved, the other support is pivoted in the opposite direction. Thereby, both of the supports move toward the middle of the cross bar at the same time.

Thus, the fixing members, which are fixed to respective supports, are decoupled from the roof racks at the same time. In this manner, the operation of only one of the fixing members allows the cross bar to be moved.

As illustrated in FIG. 4B, when the force acting on the manipulation button is removed after the cross bar is moved, the fixing members connected with the supports are coupled to the fixing holes in the roof racks by the elastic force of the coil spring 44a, which corresponds to the elastic member fixed to the central link 42, thereby fixing the cross bar.

### Second Embodiment

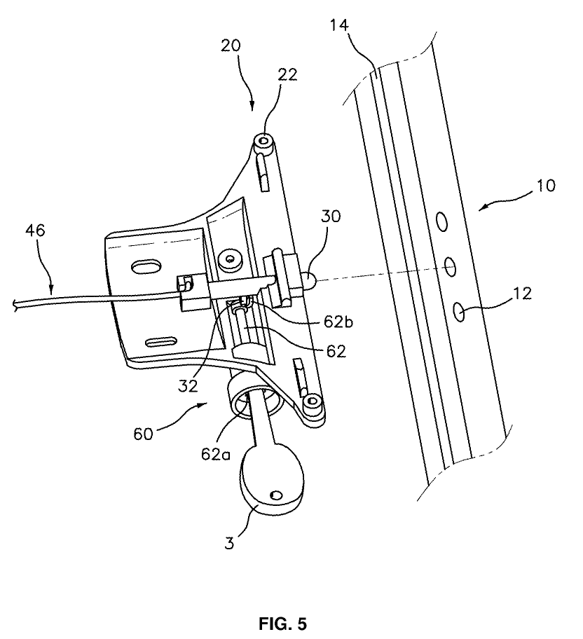

FIG. 5 is a conceptual view illustrating an apparatus for locking roof racks and cross bars of a roof carrier according to a second exemplary embodiment of the present invention.

As illustrated in FIG. 5, the apparatus for locking roof racks and cross bars of a roof carrier according to a second exemplary embodiment comprises: fixing members 30, which are constrained in each cross bar 20 and are detachably coupled to fixing holes in the roof racks 10; a connecting means 40, which is connected to the fixing members 30; and a locking unit 60, which moves the fixing members 30.

Each roof rack 10 has the fixing holes 12 formed in the inner surface thereof at regular intervals. Each cross bar 20 is preferably coupled with the roof racks 10 so as to be able to move forward and backward. To this end, each cross bar 20 is provided with rotary rollers 22 at one end thereof, which are coupled to a rail 14 formed on the inner surface of each roof rack 10.

The fixing members 30 serve to fix the cross bar 20 to the roof racks 10, are constrained in the interior of the cross bar 20, and are detachably coupled to the fixing holes 12, which are formed in the inner surfaces of the roof racks at regular intervals.

Further, each fixing member 30 is provided with a protrusion 32 on the outer circumference thereof which comes into contact with the locking unit 60.

The connecting means serves to connect the fixing members 30 with each other such that the operation of only one of the fixing members allows the other fixing member to be decoupled from its corresponding roof rack 10.

The locking unit 60 will be described in detail.

The locking unit 60 serves to move the fixing members 30, and is coupled to the cross bar, perpendicular to the moving direction of the fixing members 30, so as to be rotated at a predetermined angle. The locking unit 60 comprises a cylinder 62, which is provided with a key hole 62a in the outer surface thereof, and a connector 62b, which is in contact with the protrusion 32 of one of the fixing members 30.

The cylinder 62 is preferably designed so that a series of locking pins is disposed in a cylindrical shell and is arranged according to a profile of the key when a key is inserted into the key hole 62a, thereby unlocking a lock so that it can be rotated at a predetermined angle. The internal structure of the cylinder 62 is based on an ordinary cylindrical lock, and so a detailed description thereof will be omitted.

However, the connector 62b extends from the outer circumference to the inner end of the cylinder 62, and is in contact with the protrusion 32 of one of the fixing member in a vertical direction.

Thus, a key 3 is inserted into the key hole 62a in the cylinder until it is engaged with the cylinder, and is then turned. Thereby, the cylinder is rotated in engagement with the key. The rotation of the cylinder causes the connector 62b to be rotated, so that the connector 62b comes into contact with the protrusion 32. Thereby, one of the fixing members 30 is moved together with the other fixing member, and thus the fixing members are separated from the fixing holes 12 in the roof racks 10. As a result, the cross bar can be moved.

Further, unlike an existing locking apparatus, once the cylinder 62 is rotated and fixed, without continuing to manipulate the locking apparatus, the fixing members 30 continue to be separated from the fixing holes in the roof racks. Hence, the cross bar can be easily moved when it is moved.

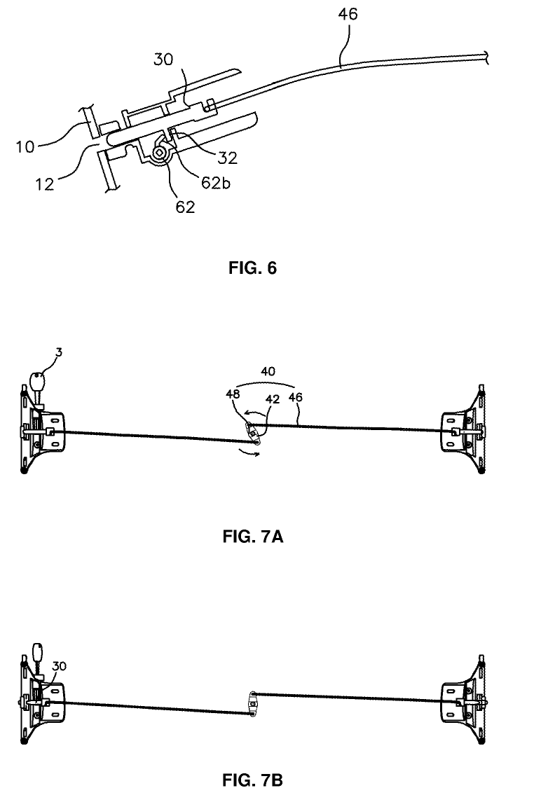

FIG. 6 is a sectional view illustrating the state in which fixing members are decoupled from fixing holes in roof racks in accordance with a second embodiment of the present invention.

As illustrated in FIG. 6, as the cylinder 62 rotates, the connector 62b, which is fixed to the cylinder, rotates to push the protrusion 32 of one of the fixing members 30. Thereby, the fixing members 30 move toward each other in opposite directions, and thereby are decoupled from the fixing holes 12 in the roof racks 10. Accordingly, the cross bar can be moved.

FIGS. 7A and 7B are views for explaining the operation of an apparatus for locking roof racks and cross bars of a roof carrier according to a second embodiment of the present invention.

Here, FIG. 7A illustrates the state in which a user operates the locking unit 60 using the key 3, and thereby the fixing members are decoupled from the fixing holes in the roof racks, and move into the interior of the cross bar, and FIG. 7B illustrates the state in which the locking unit 60 is operated again, and thereby the fixing members move toward the exterior of the cross bar again by means of the elastic force of a spring 480, and are fixed in the fixing holes in the roof racks.

When one of the supports 46, which are fixed to the opposite ends of the central link 42 in the middle of the cross bar 20, is moved, the other support is pivoted. Thereby, both of the supports 46 move toward the middle of the cross bar at the same time. Thus, the fixing members 30, which are fixed to respective supports, are decoupled from the roof racks at the same time. In this manner, the operation of only one of the fixing members allows the cross bar to be moved.

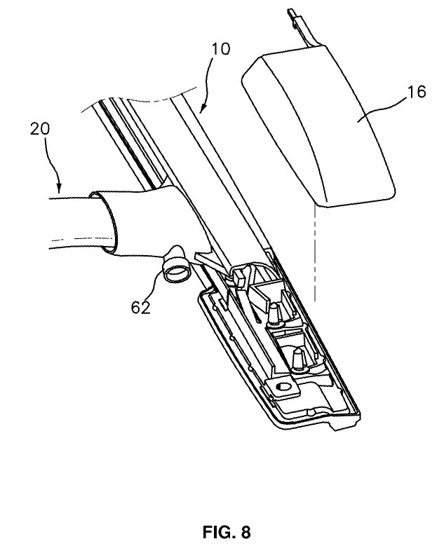

FIG. 8 is an exploded perspective view illustrating an apparatus for locking roof racks and cross bars of a roof carrier according to a second exemplary embodiment of the present invention.

As illustrated in FIG. 8, the roof carrier is generally designed to fix the roof racks to the top of the vehicle, to couple each cross bar to the roof racks, and to couple a cover 16 to one end of each roof rack to thereby prevent the separation of the cross bar.

When the cover 16 of each roof rack is removed, the cross bar can be easily separated. For this reason, there is a possibility of the cross bar being stolen. However, according to the present invention, even if the cover 16 of each roof rack 10 is removed, the cross bar cannot be separated from the roof racks, because the cylinder must be rotated using the key in order to move the fixing members, which fix the cross bar to the roof racks.

Thus, theft can be prevented, unlike the existing apparatus for locking roof racks and cross bars of a roof carrier.

### Third Embodiment

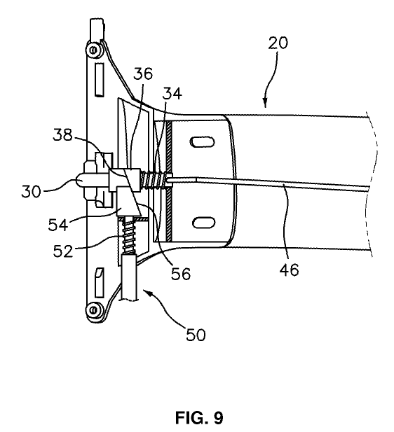

FIG. 9 is a conceptual view illustrating an apparatus for locking roof racks and cross bars of a roof carrier according to a third exemplary embodiment of the present invention.

As illustrated in FIG. 9, the apparatus for locking roof racks and cross bars of a roof carrier according to a third exemplary embodiment comprises the roof racks 10, the cross bars 20, fixing members 30, first elastic members 34, contacts 36, and manipulation buttons 50.

The first elastic members 34 are coupled to the fixing members 30, and thus serve to elastically restore the fixing members 30 to coupling positions of fixing holes 12.

In particular, each of the first elastic members 34 employs a compressive coil spring and is fixed to each fixing member 30 at one end thereof and to the interior of each cross bar 20 at the other end thereof. When the fixing members 30 are separated from the fixing holes, the first elastic members 34 are compressed. Thus, when a load acting on each fixing member 30 is released, each of the first elastic members 34 causes each fixing member 30 to be fixed in the corresponding fixing hole by its elastic force.

Further, each contact 36 protrudes from each fixing member at the interior of each cross bar 20, and is in contact with each manipulation button. Thus, each contact 36 serves to horizontally move each fixing member when each manipulation button is operated. Preferably, each manipulation button 50 is provided with a direction converter 54 at one end thereof. The direction converter 54 has a contact face 56, which is inclined at a predetermined angle with respect to the direction in which each fixing member 30 moves. Further, the manipulation buttons 50 partially protrude from and are coupled to opposite ends of the cross bar 20.

Here, when one of the manipulation buttons 50 is pushed in the inward direction of the cross bar 20, the direction converter 54 horizontally moves the contact 36 toward the middle of the cross bar 20, thereby separating the fixing members 30 from the fixing holes 12.

Further, each manipulation button 50 is preferably provided with a second elastic member 52, which exerts an elastic force, so as to be automatically restored by the elastic force.

Also, each contact 36 is preferably provided with a counter contact face 38, which is inclined at an angle corresponding to that of the contact face 56 of the direction converter 54 so that it is in contact with the contact face 56, so that it allows the fixing members 30 to be moved smoothly by the movement of each manipulation button 50.

According to the present invention, the locking apparatus further comprises a connecting means 40 for connecting the fixing member 30 at the interior of the cross bar 20.

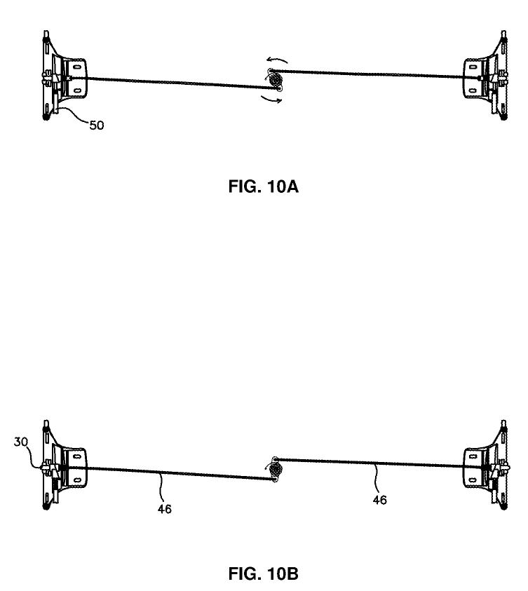

FIGS. 10A and 10B are views for explaining the operation of an apparatus for locking roof racks and cross bars of a roof carrier according to a third exemplary embodiment of the present invention.

Here, FIG. 10A illustrates the state in which the fixing members are decoupled from the fixing holes in the roof racks by the manipulation of a user, and are thereby moved into the interior of the cross bar, and FIG. 10B illustrates the state in which the fixing members are moved toward the exterior of the cross bar again by means of the elastic force of the elastic member, and are fixed in the fixing holes in the roof racks.

When the user pushes one of the manipulation buttons in order to move the cross bar, the contacts protruding from the fixing members move toward the middle of the cross bar, thereby decoupling the fixing members from the fixing holes.

Preferably, in order to completely decouple the fixing members from the fixing holes when one of the manipulation buttons is pushed, the angle that the contact face of each manipulation button and the counter contact face of each contact form with respect to the moving direction of each fixing member is adjusted by calculating the moving distance of each manipulation button and the moving distance of each fixing member.

As illustrated in FIG. 10B, when force acting on the manipulation button is released after the cross bar is moved, the fixing members, which are connected with the supports, are coupled to the fixing holes in the roof racks again by the elastic force of the elastic members, thereby fixing the cross bar.

When one of the supports, which is fixed to the opposite ends of the central link in the middle of the cross bar, is moved, the other support is pivoted in the opposite direction. Thereby, both of the supports move toward the middle of the cross bar at the same time.

Thus, the fixing members, which are fixed to respective supports, are decoupled from the roof racks at the same time. In this manner, the operation of only one of the fixing members allows the cross bar to be moved.

### Fourth Embodiment

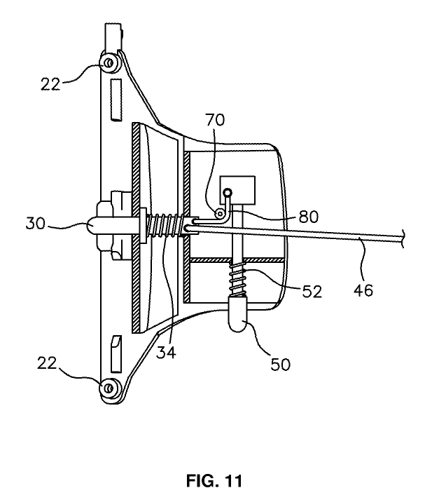

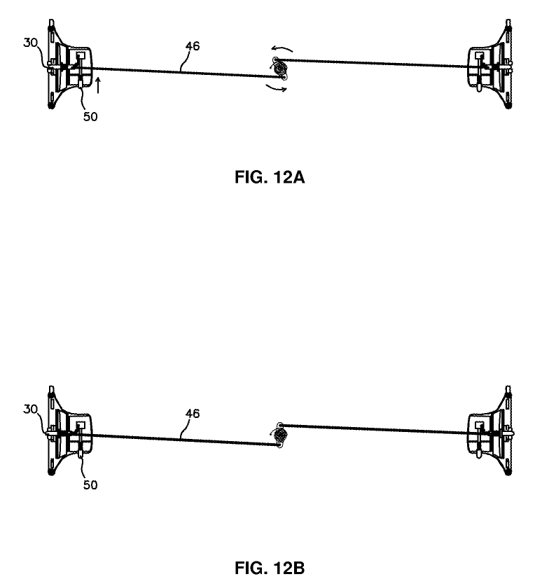

FIG. 11 is a conceptual view illustrating an apparatus for locking roof racks and cross bars of a roof carrier according to a fourth exemplary embodiment of the present invention. FIGS. 12A and 12B are views for explaining the operation of an apparatus for locking roof racks and cross bars of a roof carrier according to a fourth exemplary embodiment of the present invention.

As illustrated, the apparatus for locking roof racks and cross bars of a roof carrier according to a fourth exemplary embodiment comprises the roof racks 10, the cross bars 20, fixing members 30, first elastic members 34, manipulation buttons 50, wires 80, and fixing pins 70.

The first elastic members 34 are coupled to the fixing members 30, and serve to elastically restore the fixing members 30 to the coupling positions of fixing holes 12. As illustrated in FIG. 11, each of the first elastic members 34 employs a compressive coil spring, is fixed to each fixing member 30 at one end thereof and to the interior of each cross bar 20 at the other end thereof. When the fixing members 30 are separated from the fixing holes, the first elastic members 34 are compressed. Thus, when the force acting on each fixing member 30 is released, each of the first elastic members 34 causes each fixing member 30 to be fixed in the corresponding fixing hole by its elastic force.

Further, the manipulation buttons 50 are coupled to opposite ends of each cross bar 20 so as to be able to vertically move the cross bar 20 inward. Thus, when the user pushes one of the manipulation buttons 50 in the inward direction of the cross bar 20, the corresponding wire 80 horizontally moves one of the fixing members 30, thereby separating one of the fixing members 30 from the corresponding fixing hole 12.

Here, each wire 80 functions to transmit the force, which is applied to each manipulation button 50 by the user, to each fixing member 30, has the shape of a steel wire, and is fixed to the inner end of each manipulation button 50 at one end thereof and to each fixing member 30 at the other end thereof. Each wire 80 is preferably formed of polyurethane material, which has high flexibility and tensile strength.

Each fixing pin 70 has the shape of a circular roller, is fixed to the interior of the cross bar 20, and serves to cause each wire 80 to be connected to each manipulation button 50 and each fixing member 30 at a right angle. Each fixing pin 70 is in contact with the middle of each wire 80, and bends each wire 80 at a right angle.

Preferably, the fixing pins 70 are rotatably coupled to the interior of the cross bar, thereby minimizing the friction generated when the wires 80 are moved.

Further, each fixing pin 70 has a continuous groove in the outer circumference thereof, which is recessed in the radial inward direction. Thereby each wire 80 can be moved in close contact with each fixing pin 70.

Preferably, each manipulation button 50 comprises a second elastic member 52, which exerts an elastic force, so that it is automatically restored by the elastic force. The second elastic member 52 is a compressive coil spring, and is fixed to each manipulation button 50 at one end thereof and to the cross bar 20 at the other end thereof. When a user removes the force acting on each manipulation button 50, each manipulation button 50 is elastically restored to its initial position.

FIG. 12A illustrates the state in which the fixing members are decoupled from the fixing holes in the roof racks by the manipulation of a user, and thereby move into the interior of the cross bar, and FIG. 12B illustrates the state in which the fixing members move toward the exterior of the cross bar again by means of the elastic force of the elastic member, and are fixed in the fixing holes in the roof racks.

As illustrated, both of the fixing members are coupled to the fixing holes in the roof racks by their first elastic members, thereby maintaining the state in which the cross bar is completely fixed to the roof racks.

When the user pushes one of the manipulation buttons in order to move the cross bar, the contacts protruding from the fixing members move toward the middle of the cross bar.

At this time, one of the wires, each of which connects a corresponding manipulation button and fixing member, moves one of the fixing members, thereby decoupling the fixing members from the fixing holes.

Here, in order to convert the direction in which each fixing member is moved using the movement of one of the manipulation button, each wire is connected with a corresponding manipulation button and a corresponding fixing member through a corresponding fixing pin, thus converting the acting force caused by the movement of each manipulation button to a direction parallel to each fixing member.

Further, the fixing members are coupled with respective supports of a connecting means at ends thereof. One of the supports is moved inward, and the other support is also moved inward. Thereby, one of the fixing members is separated from the fixing hole of one of the roof racks, and the other fixing member is separated from the fixing hole of the other roof rack at the same time.

As illustrated in FIG. 12B, when force acting on the manipulation button is released after the cross bar is moved, the fixing members, which are connected with the supports, are coupled to the fixing holes in the roof racks again by the elastic force of an elastic member fixed to the central link, thereby fixing the cross bar.

Thus, the fixing members, which are fixed to respective supports, are separated from the fixing holes in the roof racks at the same time. Consequently, the operation of only one of the fixing members allows the cross bar to be moved.

As is apparent from the above description, the apparatus for locking roof racks and cross bars of a roof carrier employs a simple structure in which the fixing members are coupled to and decoupled from the fixing holes in the roof racks using the connecting means, which is fixed to the interior of the cross bar through various operating means, and includes the central link, the pair of supports connected with the central link, and the elastic member exerting an elastic force, so that it can reduce the cost of production and be easily manufactured.

The operation of only one of the operating means separates both of the fixing members from the fixing holes in the roof racks, and thus allows the cross bar to be moved, so that the apparatus for locking roof racks and cross bars of a roof carrier can be easily operated.

As described above, it will be understood that the present invention is directed to provide an apparatus, for locking the cross bar and roof racks of a roof carrier, which employs a simple structure, as a basic technical idea. Of course, those skilled in the art will appreciate that various modifications, additions and substitutions are possible, without departing from the scope and spirit of the invention as disclosed in the accompanying claims.

What is claimed is:

1. An apparatus for locking roof racks and cross bars of a roof carrier, in which the roof racks are fixed to opposite upper sides of a vehicle in a lengthwise direction of the vehicle, and each cross bar is coupled with the roof racks at opposite ends thereof in a widthwise direction of the vehicle, the apparatus comprising:
a pair of roof racks, in an inner surface of each of which a plurality of fixing holes is formed at regular intervals;
at least two cross bars, each of which is coupled to the pair of roof racks so as to be movable forwards and backwards;
a pair of fixing members, which are located at opposite ends of the cross bar and are detachably coupled to the fixing holes in the roof racks;
operating means, coupled to the opposite ends of the cross bar, for operating each fixing member to be coupled to and uncoupled from each fixing hole; and
connecting means for connecting and causing the fixing members to interact with the fixing members in the cross bar,
wherein the pair of fixing members is uncoupled from the fixing holes by operating one of the operating means.

2. The apparatus according to claim 1, wherein the operating means connects the fixing members to a pair of manipulation buttons, which protrude upward from the opposite sides of the cross bar and can horizontally move left and right, so that one of the manipulation buttons is operated to couple and decouple the pair of fixing members to and from the fixing holes in the roof racks.

3. The apparatus according to claim 1, wherein the connecting means comprises:
a central link, a center of which is pivotably fixed in a middle of an interior of the cross bar;
an elastic member, opposite ends of which are fixed to the central link and the interior of the cross bar, respectively, so as to provide a restoring force; and
a pair of supports, each of which is fixed to one end of the central link at one end thereof and is hinged to each fixing member at the other end thereof, and one of which moves to causes a remaining one thereof to move in the opposite direction.

4. The apparatus according to claim 3, wherein the elastic member comprises a spiral spring.

5. The apparatus according to claim 3, wherein the elastic member comprises a coil spring.

6. An apparatus for locking roof racks and cross bars of a roof carrier, in which the roof racks are fixed to opposite upper sides of a vehicle in a lengthwise direction of the vehicle, and each cross bar is coupled with the roof racks at opposite ends thereof in a widthwise direction of the vehicle, the apparatus comprising:
a pair of roof racks, in an inner surface of each of which a plurality of fixing holes is formed at regular intervals;
at least two cross bars, each of which is coupled to the pair of roof racks so as to be movable forwards and backwards;
a pair of fixing members, which are located at opposite ends of the cross bar and are detachably coupled to the fixing holes in the roof racks;
a protrusion, which protrudes from an outer circumference of each fixing member;
connecting means for connecting the fixing members so as to interact with the fixing members in the cross bar; and
a locking unit, which comes into contact with the protrusion and couples and decouples the fixing members to and from the fixing holes.

7. The apparatus according to claim 6, wherein the locking unit comprises:
a cylinder, which is disposed perpendicular to moving directions of the fixing members, is coupled to the cross bar so as to be able to rotate at a predetermined angle, and has a key hole in an outer surface thereof; and
a connector, which protrudes from an inner end of the cylinder and is in contact with the protrusion of one of the fixing members due to rotation of the cylinder.

8. The apparatus according to claim 6, wherein the connecting means comprises:
a central link, a center of which is pivotably fixed in a middle of an interior of the cross bar;
an elastic member, opposite ends of which are fixed to the central link and the interior of the cross bar respectively so as to provide a restoring force; and
a pair of supports, each of which is fixed to one end of the central link at one end thereof and is hinged to each fixing member at the other end thereof, and one of which moves to cause a remaining one thereof to move in the opposite direction.

9. An apparatus for locking roof racks and cross bars of a roof carrier, in which the roof racks are fixed to opposite upper sides of a vehicle in a lengthwise direction of the vehicle, and each cross bar is coupled with the roof racks at opposite ends thereof in a widthwise direction of the vehicle, the apparatus comprising:
a pair of roof racks, in an inner surface of each of which a plurality of fixing holes is formed at regular intervals;
at least two cross bars, each of which is coupled to the pair of roof racks so as to be movable forwards and backwards;
a pair of fixing members, which are located at opposite ends of the cross bar and are detachably coupled to the fixing holes in the roof racks;
first elastic members, which are coupled to the fixing members and elastically restore the fixing members to coupling positions of fixing holes;
contacts, which protrude from the fixing members; and
manipulation buttons, each of which includes a direction converter at one end thereof, the direction converter including a contact face, which is inclined at a predetermined angle with respect to a direction in which each fixing member moves,
wherein, when one of the manipulation buttons is pushed in an inward direction of the cross bar, the direction converter horizontally moves one of the contacts so as to decouple the fixing members from the fixing holes.

10. The apparatus according to claim 9, wherein each manipulation button comprises a second elastic member, exerting an elastic force.

11. The apparatus according to claim 9, wherein each contact comprises a counter contact face, which is inclined at an angle corresponding to that of the contact face of the direction converter, so as to be in contact with the contact face.

12. The apparatus according to claim 9, further comprising connecting means for connecting the fixing members so as to interact with the fixing members in the cross bar.

13. The apparatus according to claim 12, wherein the connecting means comprises:
a central link, a center of which is pivotably fixed in a middle of an interior of the cross bar;
an elastic member, opposite ends of which are fixed to the central link and the interior of the cross bar respectively so as to provide a restoring force; and
a pair of supports, each of which is fixed to one end of the central link at one end thereof and is hinged to each fixing member at the other end thereof, and one of which moves to cause a remaining one thereof to move in the opposite direction.

14. An apparatus for locking roof racks and cross bars of a roof carrier, in which the roof racks are fixed to opposite upper sides of a vehicle in a lengthwise direction of the vehicle, and each cross bar is coupled with the roof racks at opposite ends thereof in a widthwise direction of the vehicle, the apparatus comprising:
a pair of roof racks, in an inner surface of each of which a plurality of fixing holes is formed at regular intervals;
at least two cross bars, each of which is coupled to the pair of roof racks so as to be movable forwards and backwards;
a pair of fixing members, which are located at opposite ends of the cross bar and are detachably coupled to the fixing holes in the roof racks;
first elastic members, which are coupled to the fixing members and elastically restore the fixing members to coupling positions of fixing holes;
manipulation buttons, which are coupled to opposite ends of the cross bar so as to be able to move in a direction perpendicular to that in which each fixing member moves;
wires, each of which is fixed to each manipulation button and one end of each fixing member; and
fixing pins, each of which is fixed to an interior of the cross bar, and connects a corresponding wire to a corresponding manipulation button and a corresponding fixing member at a right angle,
wherein, when one of the manipulation buttons is pushed in an inward direction of the cross bar, the fixing members are decoupled from the fixing holes.

15. The apparatus according to claim 14, wherein each fixing pin is rotatably fixed to the interior of the cross bar.

16. The apparatus according to claim 14, wherein each manipulation button is coupled with a second elastic member providing an elastic force, and is elastically restored to an original position thereof when a user removes force acting thereon.

17. The apparatus according to claim 14, further comprising connecting means for connecting the fixing members so as to interact with the fixing members in the cross bar.

18. The apparatus according to claim 17, wherein the connecting means comprises:
a central link, a center of which is pivotably fixed in a middle of an interior of the cross bar;
an elastic member, opposite ends of which are fixed to the central link and the interior of the cross bar respectively so as to provide a restoring force; and
a pair of supports, each of which is fixed to one end of the central link at one end thereof and is hinged to each fixing member at the other end thereof, and one of which moves to cause a remaining one thereof to move in the opposite direction.

19. The apparatus according to claim 18, wherein the elastic member comprises a spiral spring.

20. The apparatus according to claim 18, wherein the elastic member comprises a coil spring.
